(19) United States
(12) Patent Application Publication
(10) Pub. No.: US 2023/0385863 A1
(43) Pub. Date: Nov. 30, 2023

(54) METHOD FOR TRANSPARENT ONLINE RAFFLES USING NFTS AND RANDOM GENERATORS

(71) Applicants: David Rodriguez, Odessa, FL (US); Treaven Duffy, Walnut Creek, CA (US)

(72) Inventors: David Rodriguez, Odessa, FL (US); Treaven Duffy, Walnut Creek, CA (US)

(21) Appl. No.: 18/323,308

(22) Filed: May 24, 2023

Related U.S. Application Data
(60) Provisional application No. 63/345,730, filed on May 25, 2022.

(51) Int. Cl. G06Q 30/0207; G06Q 20/12; G06Q 20/38

(52) U.S. Cl. CPC G06Q 30/0212; G06Q 20/1235; G06Q 20/389

(57) ABSTRACT

A method for transparent, online raffles is disclosed. The method provides for users to set up and hold online public raffles and solicit participants to join. Participants purchase unique tickets that are non-fungible tokens (NFTs) on a block chain. The web-based platform allows every participant to view their NFTs within the block chain's smart contract to promote fairness and transparency. The block chain also automates the random winner process, invitations, notifications and reward allocations amongst the stakeholders. An object of the invention is to provide a simple method to allow users to hold legitimate raffles online.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### Field of the Invention

The invention relates to gamification and, more specifically, to transparent, online raffles.

### Description of Related Art

The word ‘raffle’ is derived from the old French word ‘rafle’ meaning ‘dice game.’ Raffles have been in existence in one form or another since possibly the beginning of human civilization. Raffles have been used by individuals and heads of state to raise funds. The Old Testament recorded that Moses used a lottery to award land west of the Jordan to his people. The ancient Babylonians, Egyptians, Greeks, and Romans enjoyed playing raffle-like games of chance, using dice or bones to cast lots and draw winners. These simple games of chance evolved into endeavors with real fundraising potential. Subsequently, during the Hun Dynasty, the Chinese invented Keno and the money from Keno was used for civic projects, including constructing the Great Wall of China. The first raffle recorded in North America took place in Virginia in 1612. Like many raffles of today, the funds went to the community.

In modern times church groups, service clubs, community organizations, and more print tickets with individual numbers on them during raffles. As raffles began migrating online, some participants began questioning the veracity of their results and trust in raffles has been eroded due to the invisible nature of the online environment. What is needed is a way to build trust in customized, online raffle events.

### SUMMARY OF THE INVENTION

In a first implementation of the invention, the device herein disclosed and described provides a solution to the shortcomings in the prior art through the disclosure of a method for online raffles. An object of the transparent online raffle is to allow anyone with a computer and access to the internet to set up and run their own raffle online.

Another object of the transparent online raffle is to provide a means to provide transparency to the online raffle experience. The system allows users to view their ticket (NFT token) on the block chain along with other participants as well as the allotted winner, so they know the results raffle are legitimate.

Another object of the transparent online raffle is to allow users to set up rewards and specify stakeholders within the raffle environment. For example, a user can invite a large organization such as the NBA to be part of the rewards process (provide tickets to a game or pre-game party etc.) and invite members of several companies (large offices and factories etc.) to purchase tickets. Stakeholders can be solicited via social media channels or conventional email and text etc.

Another object of the transparent online raffle is to allow users to set up the parameters of a raffle event. For example, users can determine how long a raffle will be held, how many NFT tokens will be sold and for how much, who will be solicited for NFT tokens and how they will be solicited, what will be the reward and who will provide it, commission allocations and how they will be divided, how winnings will be distributed and by whom etc.

Another object of the transparent online raffle is to provide a means to include validated random selection of a winner. The system incorporates a popular random generator algorithm to ensure the winner is randomly selected from the participant pool.

Another object of the transparent online raffle is to provide a means to convert NFT tokens into a form of currency that can be used in a raffle that allows participants to select from a range of winnings. For example, a winner of a raffle can choose from items from several participating vendors each having a different value. The system converts a winning that happens to be in the form of a digital currency into a dollar amount that the vendor will accept so the prize can be released.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

The present invention is directed to a system for holding a transparent raffle event including a computer running a software application and a cloud network in communication with the computer. The software application is a non-transitory computer readable medium that includes computer readable instructions. The software application provides a system user the ability to allow participants to join raffle events, purchase NFT tokens, and observe block chain operations in real time perform logistics, and perform event activities. The transparent online raffle may allow users to set up rewards and specify stakeholders within a raffle environment. The software application may include operations that allow users to determine any combination of the following:
how long a raffle will be held;
how many NFT tokens will be sold;
how much NFT tokens will be sold for;
who will be solicited for NFT tokens;
how solicitation will be done;
what the reward will be;
who will provide the reward;
commission allocations;
how commission allocations will be divided;
how winnings will be distributed; and
by whom winnings will be distributed.

The system may include conversion of NFT tokens into a form of currency that can be used in a raffle that allows participants to select from a range of winnings. The cloud network may have operations that include administrative tasks, customization options, block chain assignments, website management, random winner generation, maintaining archives and sending notifications.

Another aspect of the present invention is directed to a method of holding a transparent raffle event. The method includes providing a computer for accessing the internet for setup and running of the transparent raffle online and providing transparency to the online raffle. The computer allows a user to view a ticket (NFT token) on a related block chain and the block chain allows other participants including an allotted winner to view the ticket (NFT token) on the related block chain, providing the other participants and the allotted winners with results of the raffle and confirming the results are legitimate. The transparent online raffle may allow users to set up rewards and specify stakeholders within the raffle environment. The event stakeholders or participants may be solicited via social media channels, email, text or the like. The transparent online raffle may allow users to set up the parameters of a raffle event. The users may be able to determine any combination of the following parameters:
how long a raffle will be held;
how many NFT tokens will be sold;
how much NFT tokens will be sold for;
who will be solicited for NFT tokens;
how solicitation will be done;
what the reward will be;
who will provide the reward;
commission allocations;
how commission allocations will be divided;
how winnings will be distributed; and
by whom winnings will be distributed.

The method may include validation of a random selection of a winner. The system may incorporate a popular random generator algorithm to ensure the winner is randomly selected from the participant pool. The method may include conversion of NFT tokens into a form of currency that can be used in a raffle that allows participants to select from a range of winnings.

Another aspect of the present invention is directed to a method of holding transparent raffle events comprising a software application and a cloud network. The software application is a non-transitory computer readable medium that includes computer readable instructions. The software application may have operations that allow users to setup raffles, select vendors, assign commissions and set logistics, set up a raffle, and view status, historical archives, send notifications and set event parameters. The software application may have operations that allow participants to join raffle events, purchase NFT tokens, and observe block chain operations in real time perform logistics and perform event activities. The wherein the cloud network may have operations that include administrative tasks, customization options, block chain assignments, website management, random winner generation, maintaining archives and sending notifications.

### BRIEF DESCRIPTION OF DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows a perspective view of the transparent online raffle in use on a mobile device.

FIG. 2 shows an embodiment of the transparent online raffle interface.

FIG. 3 shows a perspective view of a user setting up the transparent online raffle.

FIG. 4 showing a representative view of the transparent online raffle method.

FIG. 5 shows an embodiment of the transparent online raffle block chain.

FIG. 6 shows an example of a raffle screen as provided for a raffle participant or organizer.

FIG. 7 shows an example of a raffle screen as provided for a raffle participant or organizer.

FIG. 8 shows an example of a raffle screen as provided for a raffle participant or organizer.

FIG. 9 is a line drawing representation of the example of a raffle screen as provided for a raffle participant or organizer shown in FIG. 6.

FIG. 10 is a line drawing representation of the example of a raffle screen as provided for a raffle participant or organizer shown in FIG. 7.

### DETAILED DESCRIPTION OF THE INVENTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The term administrator means the person or entity which provides the online raffle system for a user or manager to set up a transparent online raffle.

The terms stakeholders and participants may be used interchangeably to mean a person or entity which accepts the raffle terms provided by the raffle user.

The terms manager and user may be used interchangeably to mean a person or entity which sets up the raffle and provides the raffle terms for raffle participant.

Describe all the embodiments as in a broad descriptive fashion without referencing the drawings.

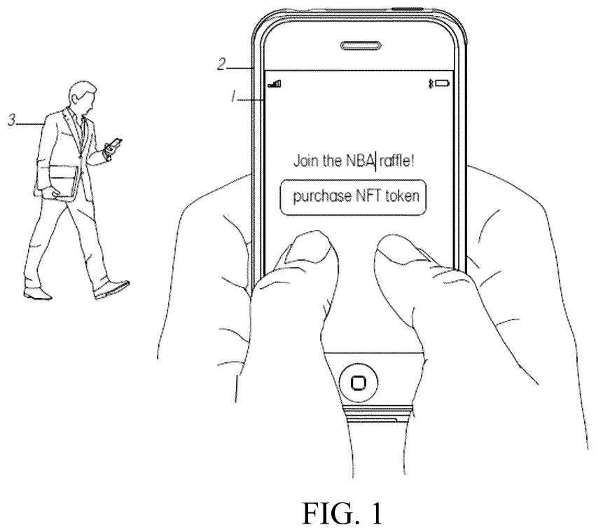

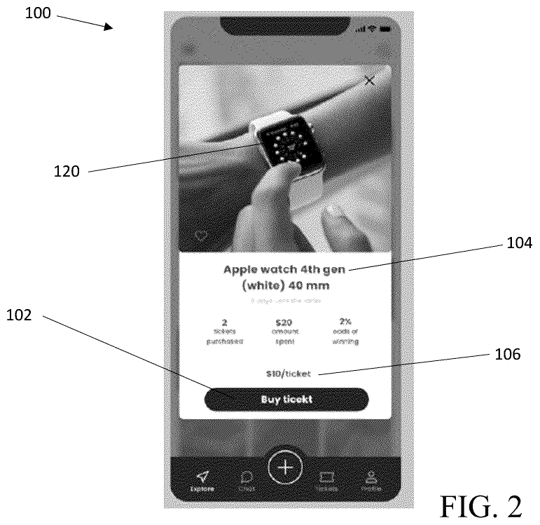

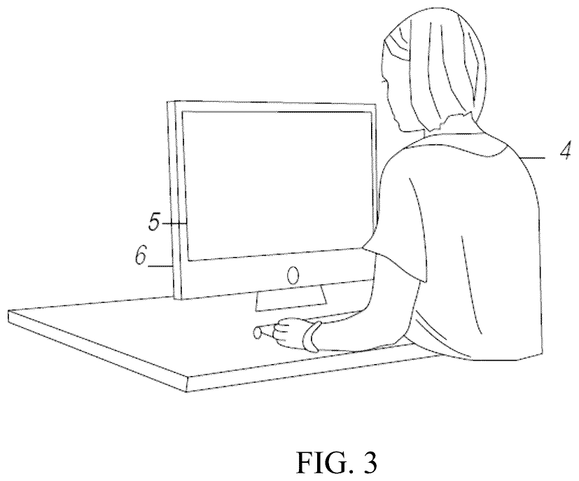

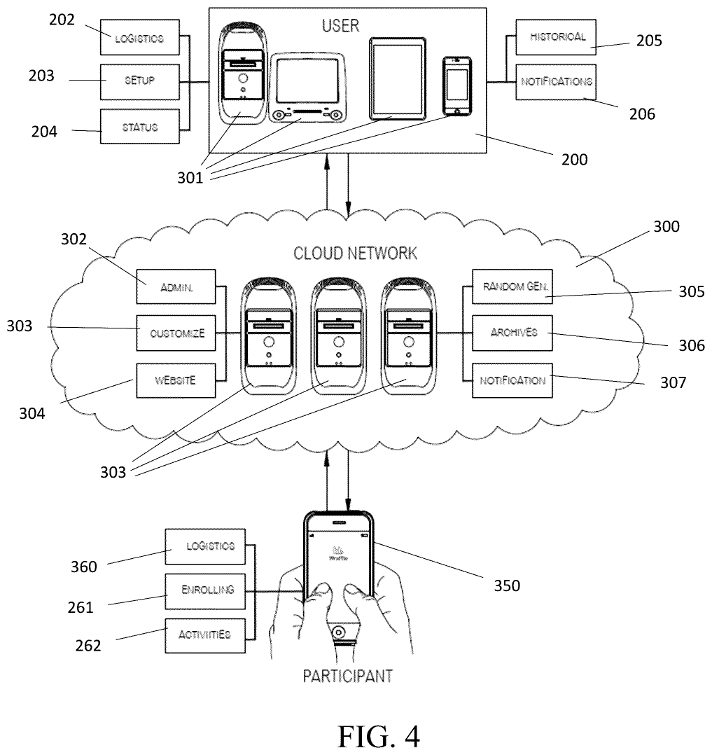

Referring now to the drawings FIGS. 1-8, and more particularly to FIG. 1, there is shown a perspective view of the transparent online raffle software application 1 (app) in use on a mobile device 2 held by a participant 3. FIG. 2 shows an embodiment of the transparent online raffle interface. The interface 100 includes a GUI which includes the photo 120 of the item to be, item listing 104, raffle cost 106 and a button 102 to purchase a raffle ticket for the item 120. FIG. 3 shows a perspective view of an organizer or raffle manager 4 setting up a transparent online raffle. FIG. 4 shows block diagram of the transparent online raffle system or method wherein managers or users have access to functions that include but are not limited to: logistics 202 (setting up an account or subscription with demographics and any payment options); setting up a raffle 203 (number of NFT tokens, pricing, duration, pool of participants, commission allotments, vendors, selecting vendor offerings and the like); status 204 (viewing raffle progress in real time—current NFT token sales, time remaining, demographics of participants, purchases made etc.); historical archives 205 (saved raffle events, transaction histories, vendor and participant contact information etc.) and notifications 206 (goals reached, social media platform connections, and allotments attained via email, text messages, SMS etc.). A user's computing device or computer 200 allows access to transparent online raffle on desktop computers, laptops, tablets, smart phones and the like. The participant 3 has functions on the participant computing device 350 that include but are not limited to logistics 360 (signing up for the service, entering demographics contact and payment options etc.); enrolling in a raffle 361 (purchasing NFT tokens, entering wallet information etc.); and activities 362 (observing block chain NFT token status in real time, making and or receiving commissions etc.). The participant and user being connected by the transparent online raffle's cloud network 300 which includes functions such as but not limited to: administrative tasks 302 (tracking user raffles, any subscriptions, converting NFT tokens to currencies for vendor winnings etc.); customization options 303 (library of pre-defined raffle event options users can choose from); transparent online raffle website 304 (raffle sign ups, status and block chain viewing status, selecting winnings etc.); random winner generation 305 (compatible with existing random generation services to determine winners etc.); archives 306 (historical database of all transparent online raffle events, encrypted and tied into the various block chains etc.); and notifications 307 (winners, reminders, alerts, invitations via text, SMS, email etc.).

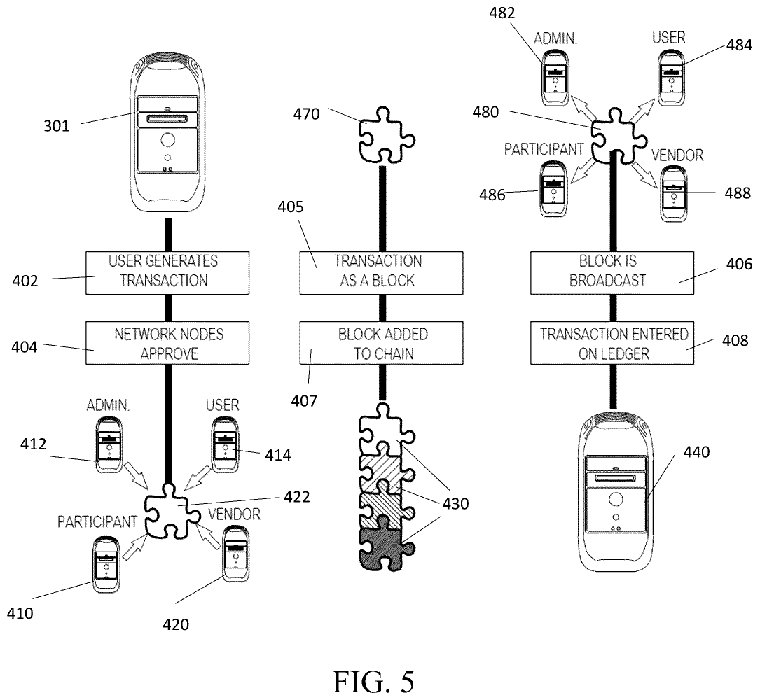

FIG. 5 shows an embodiment of the transparent online raffle block chain. The block chain software recognizes the initial transaction, and it is registered as a genesis block after being approved by network nodes made up of but not limited to: administrators, users, participants, vendors and the like. When a user continues transactions including registration, completing an exam etc., each transaction being is encrypted and added to the previous block forming a hashed block chain wherein each transaction has a timestamp and metadata that is broadcast to said authorized stakeholders as a recorded transaction and being available only on the cloud network. By design, a block chain is resistant to modification of the data. For use as a distributed ledger, the block chain is typically managed by a peer-to-peer network, collectively adhering to a protocol for inter-node communication and validating new blocks. Once recorded, the data in any given block cannot be altered retroactively, without alteration of all subsequent blocks, which requires consensus of the network majority. Combined with smart contracts, such block chains can be considered as a decentralized notary service that allows for transparency so that anyone with preset privileges can see what is inside a data element record constructed using cryptographic hash and time stamped. Smart contracts are dynamic, live contracts that once created cannot be changed but can perform certain actions when certain conditions are met—such as sharing records automatically with pre-approved parties using digital signatures. In the current disclosure, the block chain allows all raffle transactions to take place on the decentralized smart contract and tokens may be based on BEP-20.

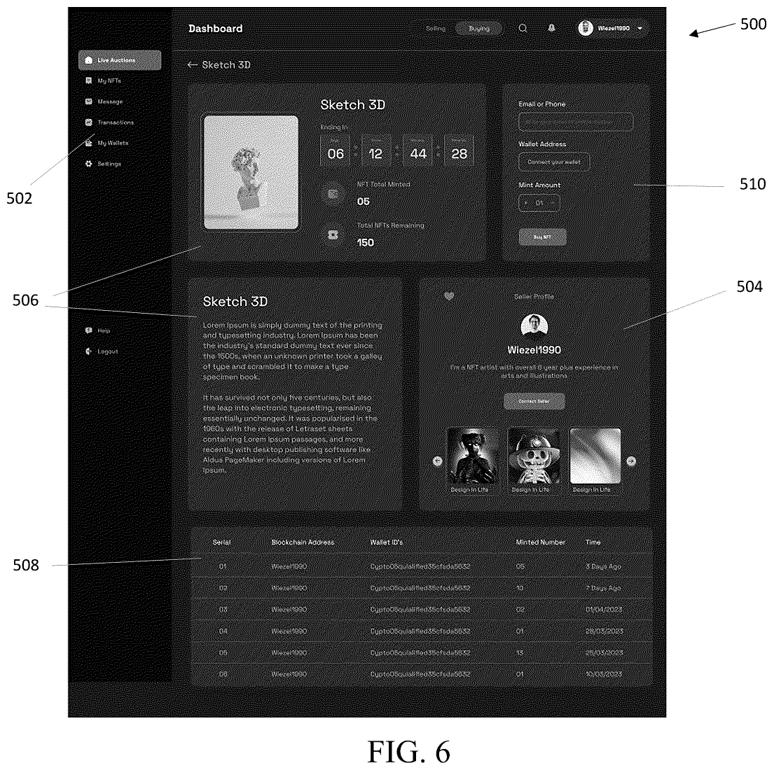

In an embodiment of the present invention shown in FIGS. 3-5 and the raffle examples in FIGS. 6-8, a system for holding a transparent raffle event includes at least one computing device 301 running a software application 200 and a cloud network 300 in communication with the computer 301. The software application 200 is a non-transitory computer readable medium that includes computer readable instructions. The software application 200 provides a system user 4 the ability to allow participants 3 to join raffle events, purchase NFT tokens, and observe block chain operations in real time perform logistics and perform event activities. The transparent online raffle allows users 4 to set up rewards and specify stakeholders within a raffle environment. The software application may include operations that allow users 4 to determine any combination of the following:
how long a raffle will be held;
how many NFT tokens will be sold;
how much NFT tokens will be sold for;
who will be solicited for NFT tokens;
how solicitation will be done;
what the reward will be;
who will provide the reward;
commission allocations;
how commission allocations will be divided;
how winnings will be distributed; and
by whom winnings will be distributed.

The system may include conversion of NFT tokens into a form of currency that can be used in a raffle that allows participants 3 to select from a range of winnings. The cloud network may have operations that include administrative tasks, customization options, block chain assignments, website management, random winner generation, maintaining archives and sending notifications.

Another aspect of the present invention is directed to a method of holding a transparent raffle event. The method as shown in FIG. 4 includes providing a computing device or computer 301 for accessing the internet for setup and running of the transparent raffle online and providing transparency to the online raffle. Managers or users have access to functions that include but are not limited to: logistics 202 (setting up an account or subscription with demographics and any payment options); setting up a raffle 203 (number of NFT tokens, pricing, duration, pool of participants, commission allotments, vendors, selecting vendor offerings and the like); status 204 (viewing raffle progress in real time—current NFT token sales, time remaining, demographics of participants, purchases made etc.); historical archives 205 (saved raffle events, transaction histories, vendor and participant contact information etc.) and notifications 206 (goals reached, social media platform connections, and allotments attained via email, text messages, SMS etc.). A user's computing device or computer 200 allows access to transparent online raffle on desktop computers, laptops, tablets, smart phones and the like. The participant 3 has functions on the participant computing device 350 that include but are not limited to logistics 360 (signing up for the service, entering demographics contact and payment options etc.); enrolling in a raffle 361 (purchasing NFT tokens, entering wallet information etc.); and activities 362 (observing block chain NFT token status in real time, making and or receiving commissions etc.). The participant and user being connected by the transparent online raffle's cloud network 300 which includes functions such as but not limited to: administrative tasks 302 (tracking user raffles, any subscriptions, converting NFT tokens to currencies for vendor winnings etc.); customization options 303 (library of pre-defined raffle event options users can choose from); transparent online raffle website 304 (raffle sign ups, status and block chain viewing status, selecting winnings etc.); random winner generation 305 (compatible with existing random generation services to determine winners etc.); archives 306 (historical database of all transparent online raffle events, encrypted and tied into the various block chains etc.); and notifications 307 (winners, reminders, alerts, invitations via text, SMS, email etc.). As shown in FIG. 5, the computer 301 allows a user 484 to view a ticket (NFT token) on a related block chain and the block chain allows other participants including an allotted winner to view the ticket (NFT token) on the related block chain (see blocks 405, 407, 422, 430, 470 and 480) providing the other participants 486 and the allotted winners with results of the raffle and confirming the results are legitimate. An administrator 412 sets up the system coordination for the participant 410, vendor 420 and the user 410 and the computer prompts the steps of a user generating a transaction 402 and the approval of network nodes 404. The blockchain events or transitioning 405 and adding the block to the chain 407 are part of the blockchain system used in the transactions. This allows the block to be broadcast 406 and have the related transaction entered on to the blockchain ledger 408. The transparent online raffle may allow users to set up rewards and specify stakeholders within the raffle environment. The event stakeholders or participants may be solicited via social media channels, email, text or the like. The transparent online raffle may allow users 484 to set up the parameters of a raffle event. The users 484 may be able to determine any combination of the following parameters:
how long a raffle will be held;
how many NFT tokens will be sold;
how much NFT tokens will be sold for;
who will be solicited for NFT tokens;
how solicitation will be done;
what the reward will be;
who will provide the reward;
commission allocations;
how commission allocations will be divided;
how winnings will be distributed; and
by whom winnings will be distributed.

The method may include validation of a random selection of a winner. The system may incorporate a popular random generator algorithm to ensure the winner is randomly selected from the participant pool. The method may include conversion of NFT tokens into a form of currency that can be used in a raffle that allows participants to select from a range of winnings.

Another aspect of the present invention is directed to a method of holding transparent raffle events comprising a software application and a cloud network. The software application is a non-transitory computer readable medium that includes computer readable instructions. The software application may have operations that allow users to setup raffles, select vendors, assign commissions and set logistics, set up a raffle, and view status, historical archives, send notifications and set event parameters. The software application may have operations that allow participants to join raffle events, purchase NFT tokens, and observe block chain operations in real time perform logistics and perform event activities. The wherein the cloud network may have operations that include administrative tasks, customization options, block chain assignments, website management, random winner generation, maintaining archives and sending notifications.

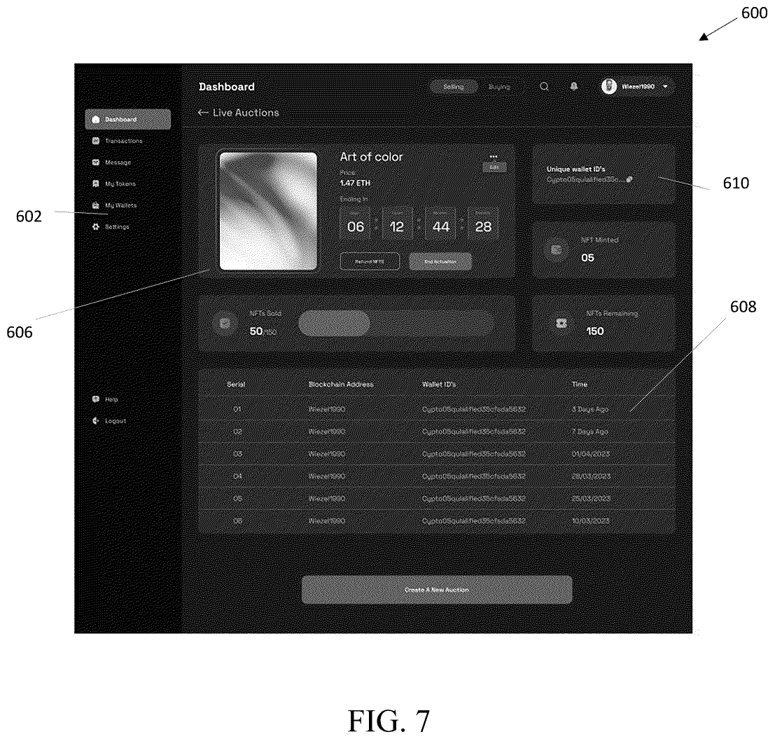

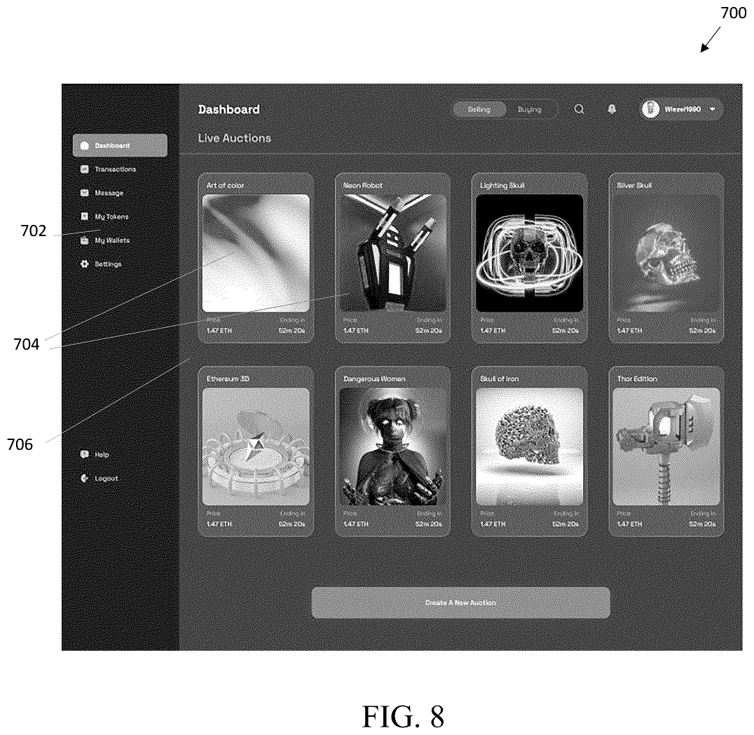

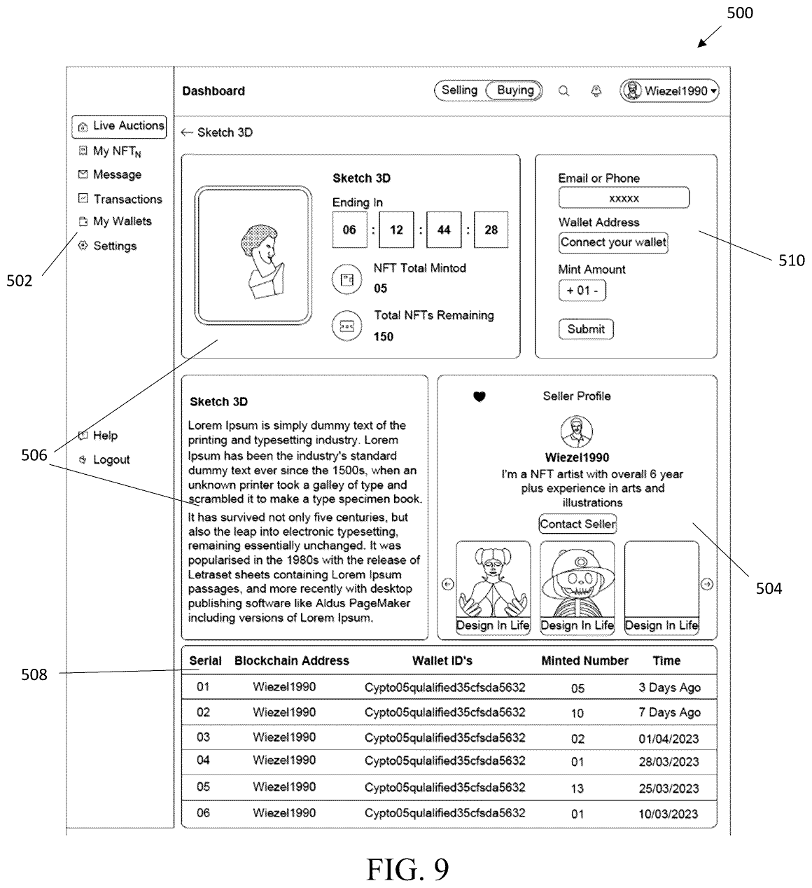

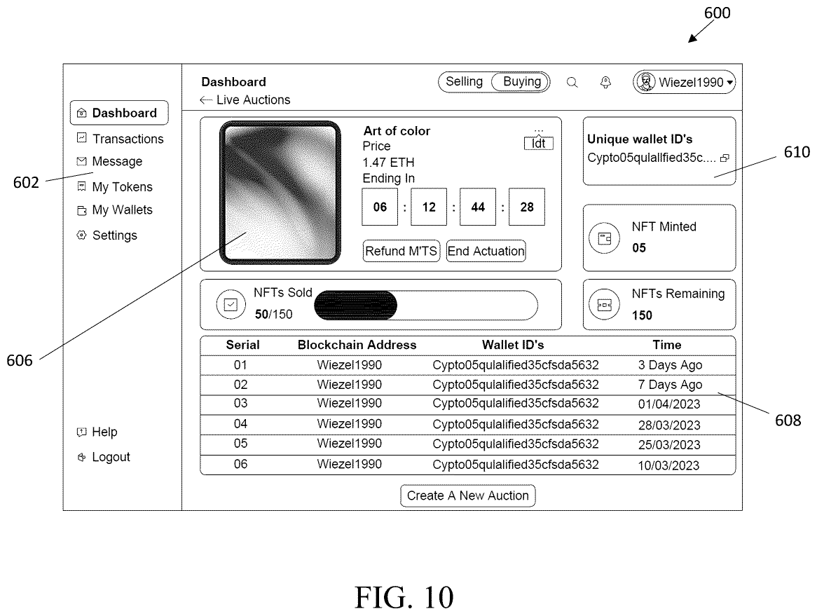

FIGS. 6-10 show screenshot examples of raffle dashboards as viewed by a participant 3. A first example 500 in FIGS. 6 and 9 shows a dashboard having a site map 502, user information board 504, at least one NFT information board 506, blockchain information board 508 and a wallet board 510. A second example 600 in FIGS. 7 and 10 shows a dashboard having a site map 602, NFT information board 606, blockchain information board 608 and a wallet board 610. A third example 700 in FIG. 8 shows a dashboard having a site map 702, NFTs 704 and NFT information board 706.

In view of the disclosure provided herein, a mobile application is created by techniques known to those of skill in the art using hardware, languages, and development environments known to the art. Those of skill in the art will recognize that mobile applications are written in several languages include, by way of non-limiting examples, C, C++, C #, Objective-C, Java™, Javascript, Pascal, Object Pascal, Python™, Ruby, VB.NET, WML, and XHTML/HTML with or without CSS, or combinations thereof. The software also compatible with a plurality of operating systems such as, but not limited to: Windows, Apple, and Android, and compatible with a multitude of hardware platforms such as, but not limited to: personal desktops, laptops, tablets, smartphones and the like. Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome Web Store, BlackBerry® App World, App Store for Palm devices, App Catalog for webOS, Windows® Marketplace for Mobile, Ovi Store for Nokia® devices, Samsung® Apps, and Nintendo® DSi Shop.

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications. In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A system for holding a transparent raffle event comprising:
a computer running a software application; and
a cloud network in communication with the computer;
wherein the software application is a non-transitory computer readable medium that includes computer readable instructions; and
wherein the software application provides a system user the ability to allow participants to join raffle events, purchase NFT tokens, and observe block chain operations in real time perform logistics and perform event activities.

2. The system for holding a transparent raffle event according to claim 1 wherein the transparent online raffle allows users to set up rewards and specify stakeholders within a raffle environment.

3. The system for holding a transparent raffle event according to claim 1 wherein the software application includes operations that allow users to determine any combination of the following:
a. how long a raffle will be held;
b. how many NFT tokens will be sold;
c. how much NFT tokens will be sold for;
d. who will be solicited for NFT tokens;
e. how solicitation will be done;
f. what the reward will be;
g. who will provide the reward;
h. commission allocations;
i. how commission allocations will be divided;
j. how winnings will be distributed; and
k. by whom winnings will be distributed.

4. The system for holding a transparent raffle event according to claim 1 including conversion of NFT tokens into a form of currency that can be used in a raffle that allows participants to select from a range of winnings.

5. The system for holding a transparent raffle event according to claim 1 wherein the cloud network has operations that include administrative tasks, customization options, block chain assignments, website management, random winner generation, maintaining archives and sending notifications.

6. A method of holding a transparent raffle event comprising:
providing a computer for accessing the internet for setup and running of the transparent raffle online;
providing transparency to the online raffle;
wherein the computer allows a user to view a ticket (NFT token) on a related block chain; and
wherein the block chain allows other participants including an allotted winner to view the ticket (NFT token) on the related block chain, providing the other participants and the allotted winners with results of the raffle and confirming the results are legitimate.

7. The method of holding a transparent raffle event according to claim 6 wherein the transparent online raffle allows users to set up rewards and specify stakeholders within the raffle environment.

8. The method of holding a transparent raffle according to claim 6 wherein event stakeholders are solicited via social media channels.

9. The method of holding a transparent raffle according to claim 6 wherein event stakeholders are solicited via email.

10. The method of holding a transparent raffle according to claim 6 wherein event stakeholders are solicited via text.

11. The method of holding a transparent raffle event according to claim 6 wherein the transparent online raffle allows users to set up the parameters of a raffle event.

12. The method of holding a transparent raffle according to claim 11 wherein users can determine any combination of the following parameters:
a. how long a raffle will be held;
b. how many NFT tokens will be sold;
c. how much NFT tokens will be sold for;
d. who will be solicited for NFT tokens;
e. how solicitation will be done;
f. what the reward will be;
g. who will provide the reward;
h. commission allocations;
i. how commission allocations will be divided;
j. how winnings will be distributed; and
k. by whom winnings will be distributed.

13. The method of holding a transparent raffle event according to claim 6 including validation of a random selection of a winner.

14. The method of holding a transparent raffle event according to claim 13 wherein the system incorporates a popular random generator algorithm to ensure the winner is randomly selected from the participant pool.

15. The method of holding a transparent raffle event according to claim 6 conversion of NFT tokens into a form of currency that can be used in a raffle that allows participants to select from a range of winnings.

16. A method of holding transparent raffle events comprised of the following parts:
a) a software application; and
b) a cloud network.

17. The method of holding transparent raffle events of claim 16, wherein the software application is a non-transitory computer readable medium that includes computer readable instructions.

18. The method of holding transparent raffle events of claim 16, wherein the software application having operations that allow users to setup raffles, select vendors, assign commissions and set logistics, set up a raffle, and view status, historical archives, send notifications and set event parameters.

19. The method of holding transparent raffle events of claim 16, wherein the software application having operations that allows participants to join raffle events, purchase NFT tokens, and observe block chain operations in real time perform logistics and perform event activities.

20. The method of holding transparent raffle events of claim 16, wherein the cloud network has operations that include administrative tasks, customization options, block chain assignments, website management, random winner generation, maintaining archives and sending notifications.
